(19) United States
(12) Patent Application Publication
(10) Pub. No.: US 2005/0069396 A1
(43) Pub. Date: Mar. 31, 2005

(54) Screw

(76) Inventor: Keng Shui Wu, Yungkang City (TW)

Correspondence Address: Keng Shui Wu;No. 6, Alley 10, Lane 779, Chungchengnan Rd., P.O. Box 2-10, Tainan City, TW

(21) Appl. No.: 10/679,019

(22) Filed: Sep. 30, 2003

(51) Int. Cl. F16B 35/04

(52) U.S. Cl. 411/411

(57) ABSTRACT

A screw includes a head and a shank provided with screwing threads and cutting threads. Each thread of the screwing threads and each thread of the cutting threads are positioned to form an angle φ so that the screw can smoothly move in a wooden object by means of the screwing threads in screwing in the wooden object, lowering screwing toque by means of the cutting threads, and thus enhancing locking force of the screw against the wooden object.

### FIELD OF THE INVENTION

This invention relates to a screw, particularly to one smoothly screwing in an object and lowering its torque needed for screwing and enhancing the tightening and locking force of the screw against a wooden object at the same time.

### BACKGROUND OF THE INVENTION

A first conventional screw disclosed in the U.S. Pat. No. 4,834,602 shown in FIG. 3 includes two separated sections of screwing threads 10, 11, and cutting threads 12 interposed between the two screwing threads 10, 11. The cutting threads 12 function to scrape and drill a hole and convey cut wooden bits out of the hole. In screwing, the screw is first inserted in an object with the screwing threads 10 by squeezing, and also keeps the screw upright, preventing the screw from swaying. Then the cutting threads 12 scrape the wooden object and bore a rather large hole in it and the screwing threads 11 gradually screw in the object, and finally lock the object. Although the first conventional screw has the function of keeping it from swaying and lowering partial torque (or friction), depending on the lower screwing threads 10 for squeezing firstly in an object, not completely solving the problem of the torque needed. Furthermore, the hole bored by the cutting threads 12 is a bit smaller than the diameter of the screwing threads 10 and 11 so that the locking force of the screw against the object is not enough, with the screw liable to loosen and separate from the object by external force.

A second conventional screw disclosed in a U.S. Pat. No. 4,241,638 shown in FIG. 2 includes first helical threads 20 and second helical threads 21 and third helical threads 23 having a different guiding angle from that of the first and the second helical threads 20 and 21. The third helical threads 23 are used to scrape a thin object, and the first and the second helical threads 20 and 21 screw in the object. When the second conventional screw is driven in a wooden object, it is only squeezed therein, without scraping function so that there may occur excessive torque and rifting of the wooden object.

A third conventional screw disclosed in a U.S. Pat. No. 5,015,134 includes incomplete threads 5, 5′ and cutting threads 6 and 7. When the third conventional screw is driven in a wooden object, the incomplete threads 5′ is first squeezed in the wooden object, and keeps the screw upright and not easily swaying, and then the cutting threads 6 destroys the thread grooves already formed to bore a little larger hole. After that the incomplete threads 5 screw in the object gradually, the third conventional screw can function to avoid swaying and to lower partial torque (or friction), but needs the incomplete threads 5′ to first squeeze the object, not solving completely the problem of handling torque. Moreover, the holes 6 and 7 bored by the cutting threads are a bit smaller than the diameter of the screwing threads 5, resulting in the insufficient tightening and locking force of the screw 1 against the object, with the screw liable to loosen and separate from the object by exterior force.

### SUMMARY OF THE INVENTION

The purpose of the invention is to offer a screw needing a small torque in screwing and little swaying in screwing, and having upgraded locking and tightening force against a wooden object.

A first feature of the invention is that cutting threads and screwing threads formed on a shank of a screw are provided with different guiding angles from each other for screwing process.

A second feature of the invention is that the cutting threads and the screwing threads are formed with an angle φ so that the screw can move smoothly in an wooden object by means of the screwing threads, and the cutting threads scrapes the wooden object to lower torque required in screwing and also to upgrade locking force of the screw against the wooden object.

### BRIEF DESCRIPTION OF DRAWINGS

This invention will be better understood by referring to the accompanying drawings, wherein:

FIG. 1 is a side view of a first conventional screw;

FIG. 2 is a partial side view of a second conventional screw;

FIG. 3 is a perspective view of a first embodiment of a screw in the present invention;

FIG. 4 is a side view of the first embodiment of a screw in the present invention;

FIG. 5 is a cross-sectional view of the line A-A in FIG. 4;

FIG. 6 is a magnified partial view of the part marked (A) in FIG. 4; and,

FIG. 7 is a perspective view of a second embodiment of a screw in the present invention.

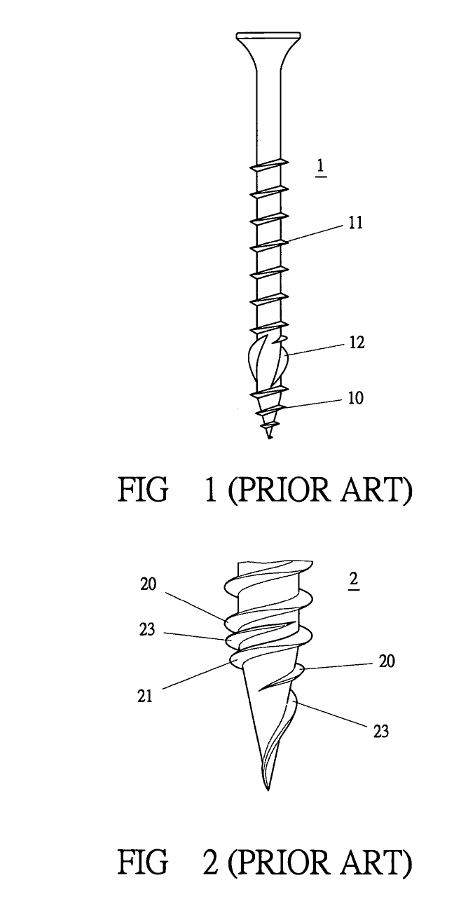

### DETAILED DESCRIPTION OF THE INVENTION

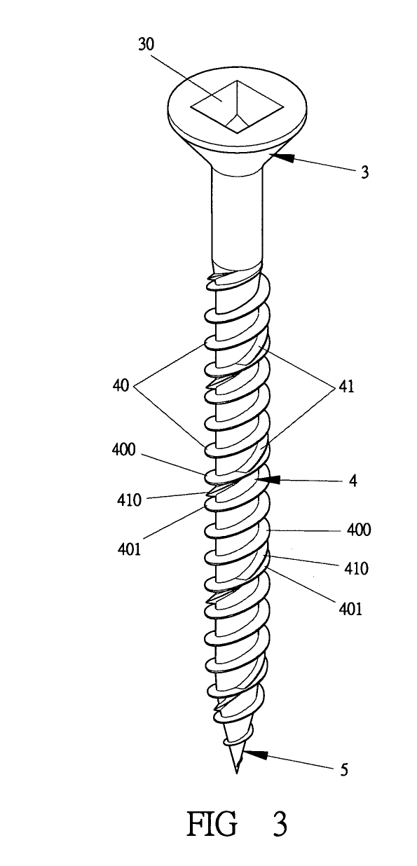

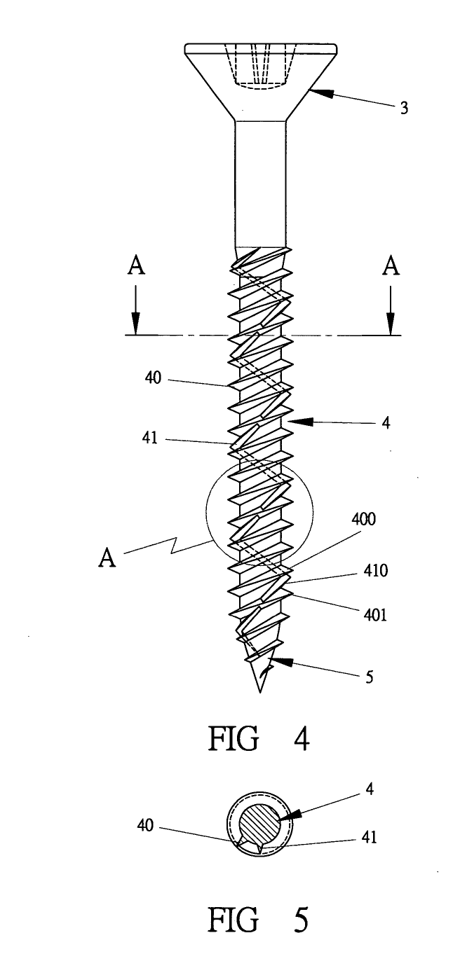

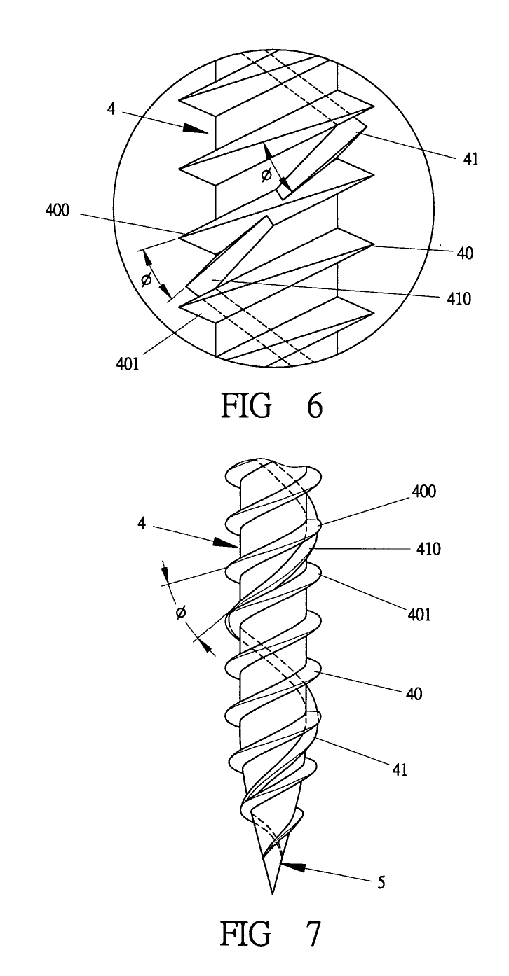

A first preferred embodiment of a screw in the present invention, as shown in FIGS. 3-6, includes a head 3, a shank 4 and a lower cone-shaped end portion 5.

The head 3 is provided with a central recess 30, and the shapes of the head 3 and the central recess are not limited, so long as they suit to a tool used for driving the screw.

The shank 4 is round and elongate, provided with screwing threads 40 and cutting threads 41, and both the threads 40 and 41 are formed to have the same helical direction, but different guiding angles, extending upward from the lower cone-shaped end portion 5 to its upper end positioned a little lower from the head 3. Then the screw of the first embodiment can smoothly be driven in a wooden object and have extremely excellent scraping and locking force, lowering the torque needed in screwing. The cutting threads 41 are formed to have each cutting thread 410 positioned between every two screwing threads 400 and 401 of the screwing threads 40, with an angle φ formed between the two threads 400 and 401 and the cutting thread 410. Then the first screw has a function of smooth scraping and screwing and tight locking by means of the screwing threads 40 of tight screwing and locking and the cutting threads 41 of sharp scraping.

Next, as shown in FIG. 7, a second preferred embodiment of a screw also includes a head 3, a shank 4 and a lower cone-shaped end portion 5. The shank 3 is provided with screwing threads 40 and cutting threads 41A. The both threads 40 and 41A are positioned counter in their helical directions and have different guiding angles. The screwing threads 40 and the cutting threads 41A both extend upward from the lower cone-shaped end portion 5 to the upper end located a little lower from the head 2. The second screw has the same function as the first screw.

The screw in the invention has the following advantages, as can be seen from the aforesaid description.
1. Scraped wooden bits produced by the screw cannot clogged by the screwing threads, possible to be delivered out of a wooden object by the cutting threads,
2. A wooden object locked by the screw is not liable to rift, with torque needed for driving the screw reduced and its locking force enhanced.

While the preferred embodiments of the invention have been described above, it will be recognized and understood that various modifications may be made therein and the appended claims are intended to cover all such modifications that may fall within the spirit and scope of the invention.

1. A screw comprising:
a head provided with a central recess, said head and said central recess having any shape to suit to various tools: and,
a shank having a proper length and screwing threads and cutting threads, said screwing threads and said cutting threads respectively having different guiding angles from each other and the both threads extending upward from a lower cone-shaped end portion to an upper end a little lower from said head, each thread of said screwing threads and each of said cutting thread forming an angle φ.

2. The screw as claimed in claim 1, wherein said screwing threads and said cutting threads on said shank are positioned to have counter directions from each other, and respectively different guiding angles, extending upward from said lower cone-shaped end portion to an upper end a little lower from said head.
